(19) United States
(12) Patent Application Publication
(10) Pub. No.: US 2017/0027113 A1
(43) Pub. Date: Feb. 2, 2017

(54) PLANT PROTECTION AND WATER SAVING DEVICE

(71) Applicant: Robert Derek Rugheimer, Benoni (ZA)

(72) Inventor: Robert Derek Rugheimer, Benoni (ZA)

(21) Appl. No.: 14/997,145

(22) Filed: Jan. 15, 2016

(30) Foreign Application Priority Data
Jul. 27, 2015 (ZA) 2015/05384

(51) Int. Cl. A01G 13/02; A01G 25/02; B65D 5/00

(52) U.S. Cl. CPC A01G 13/0237; B65D 5/008; A01G 25/02

(57) ABSTRACT

A blank for a plant protection and water saving device includes four generally trapezoidal panels arranged in a row and connected to each other at a widest part of each panel, which panels in use form four side walls of the device. Two flaps each extend from one trapezoidal panel at a narrowest part of the panel, with a cut-out being defined at a free leading edge of each flap and several spaced apart lines of weakness being provided around the cut-out. The blank is manufactured from a fluted sheet material.

### CROSS REFERENCE TO RELATED APPLICATIONS

This application claims priority to Republic of South Africa patent application no. 2015/05384, filed Jul. 27, 2015. The disclosure set forth in the referenced application is incorporated herein by reference in its entirety.

### FIELD OF THE INVENTION

This invention relates to a plant protection and water saving device which finds particular application in the cultivation of trees.

### BACKGROUND OF THE INVENTION

The inventor is aware of an invention disclosed in U.S. Pat. No. 8,296,995 which relates to a frusto-conical device that is placed around a bottom of a tree stem or trunk. In practice, the device is manufactured from a recycled synthetic plastics material. Various embodiments of the device are disclosed in the U.S. patent to accommodate growing tree trunks that have become too big for the device they were originally fitted with.

Apart from being expensive to manufacture, the device disclosed in U.S. Pat. No. 8,296,995 requires fastening means to attach parts of the device to each other after it has been placed around a tree stem or trunk and a single device cannot accommodate various trunk diameters. Although the device can be transported by nesting or stacking a plurality of devices, the devices take up a lot of space during transport therefor.

The inventor believes that a need exists for providing a plant protection and water saving device which overcomes at least some of the deficiencies described above.

### SUMMARY OF THE INVENTION

According to the invention, there is provided a blank for a plant protection and water saving device, the blank including:
(a) four generally trapezoidal panels arranged in a row and connected to each other at a widest part of each panel, which panels in use form four side walls of the device;
(b) two flaps, each extending from one trapezoidal panel at a narrowest part of the panel, a cut-out being defined at a free leading edge of each flap and several spaced apart lines of weakness being provided around the cut-out; and
(c) male and female engaging formations arranged at free sides of the panels and flaps to permit fastening of the panels and flaps to each other in use; wherein the blank is manufactured from a fluted sheet material.

Each flap may be rectangular in shape.

The cut-outs and the lines of weakness around it may be semi-circular.

The lines of weakness may permit portions of the flaps around the cut-outs to be removed when desired.

The female engaging formations may be in the form of slots.

The male engaging formations may be generally T-shaped and include a neck portion that is slightly narrower than the slots and a head portion that is wider than the slots.

In use, panels are joined by twisting a head portion and inserting it through a slot after which the head portion is allowed to return to its original position.

In a preferred embodiment of the invention, two adjacent panels of the row are provided with spaced apart male engaging formations extending from free edges of the panels and the other two panels are provided with female engaging formations.

The blank may be manufactured from a synthetic plastics material or from cardboard.

The blank may be manufactured from Correx Board.

Two of the trapezoidal panels may include a cut-out arranged toward the widest part of the panels for in use receiving a water conduit therethrough.

A fluid atomiser may in use extend from the conduit and may terminate in an interior of the device.

### DETAILED DESCRIPTION OF THE INVENTION

The invention will now be described by way of the following, non-limiting example with reference to the accompanying drawings.

### BRIEF DESCRIPTION OF THE DRAWINGS

In the drawings:

FIG. 1 shows a top view of a blank for a plant protection and water saving device in accordance with the present invention; and

FIG. 2 shows a three-dimensional view of the blank of FIG. 1 in use after it has been folded into a plant protection and water saving device.

In the drawings, reference numeral 10 generally indicates an embodiment of a blank for a plant protection and water saving device in accordance with the present invention.

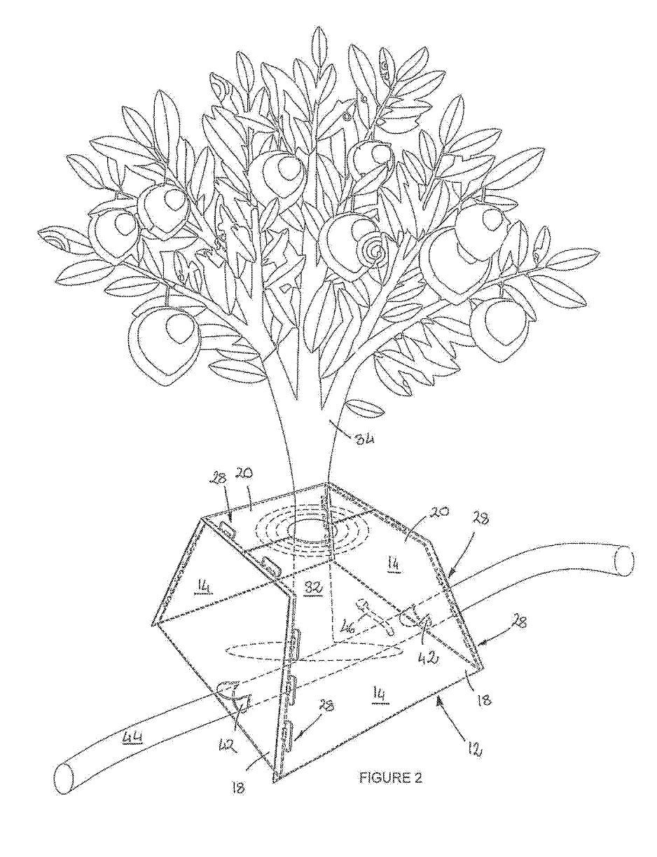

A blank 10 for a plant protection and water saving device 12 includes four generally trapezoidal panels 14 arranged in a row 16 and connected to each other at a widest part 18 of each panel 14, which panels 14 in use form four side walls of the device 12 as shown in FIG. 2.

Two flaps 20 each extend from one trapezoidal panel 14 at a narrowest part 22 of the panel, with a cut-out 24 being defined at a free leading edge of each flap 20 and several spaced apart lines of weakness 26 being provided around the cut-out 24.

Male and female engaging formations 28 and 30 respectively, are arranged at free sides of the panels 14 and flaps 20 to permit fastening of the panels 14 and flaps 20 to each other in use as shown in FIG. 2.

The blank 10 is manufactured from a fluted sheet material.

Each flap 20 is rectangular in shape.

The cut-outs 24 and the lines of weakness 26 around it are semi-circular.

The lines of weakness 26 permit portions of the flaps 20 around the cut-outs 24 to be removed when desired, i.e. when the stem 32 of a tree 34 extending through the cut-out as shown in FIG. 2 has become bigger than the aperture defined by the cut-out 24. In this manner, it is not necessary to provide different devices 12 for tree stems 32 of different diameters.

The female engaging formations 30 are in the form of slots 36.

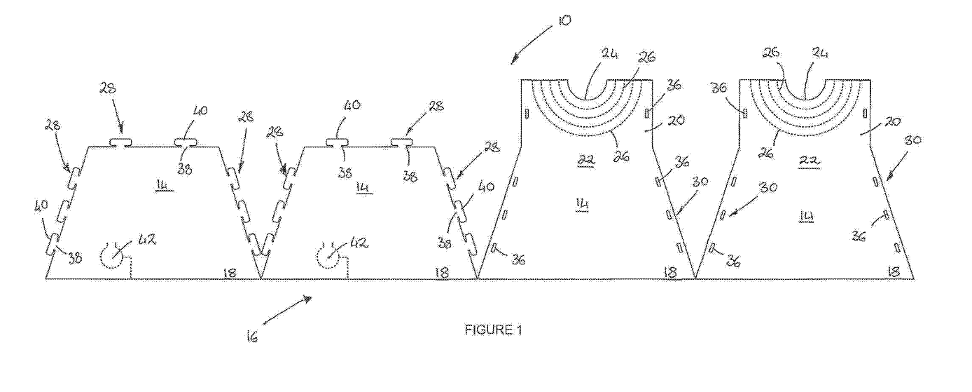

The male engaging formations 28 are generally T-shaped and include a neck portion 38 that is slightly narrower than the slots 36 and a head portion 40 that is wider than the slots 36 as can best be seen in FIG. 1.

In use, panels 14 are joined by twisting a head portion 40 and inserting it through a slot 36 after which the head portion 40 is allowed to return to its original position.

In a preferred embodiment of the invention, two adjacent panels 14 of the row 16 are provided with spaced apart male engaging formations 28 extending from free edges of the panels 14 and the other two panels 14 are provided with female engaging formations 30.

The blank 10 is manufactured from a synthetic plastics material or from cardboard.

In a preferred embodiment, the blank 10 is manufactured from Correx Board.

Two of the trapezoidal panels 14 include a circular cut-out 42 arranged toward the widest part of the panels 14 for in use receiving a water conduit 44 therethrough.

A fluid atomiser 46 in use extends from the conduit 44 and terminates in an interior of the device 12. In this manner, water flowing through the conduit 44 is fed to the interior of the device 12 and evaporation of the water is largely inhibited by the device 12.

This presents a significant water saving whilst the device 12 at the same time acts as protection against insects and the elements for the portion of the stem 32 which it surrounds.

It is to be appreciated, that the invention is not limited to any particular embodiment or configuration as hereinbefore described and/or illustrated.

1. A blank for a plant protection and water saving device, the blank including:
(a) four generally trapezoidal panels arranged in a row and connected to each other at a widest part of each panel, which panels in use form four side walls of the device;
(b) two flaps, each extending from one trapezoidal panel at a narrowest part of the panel, a cut-out being defined at a free leading edge of each flap and several spaced apart lines of weakness being provided around the cut-out; and
(c) male and female engaging formations arranged at free sides of the panels and flaps to permit fastening of the panels and flaps to each other in use; wherein the blank is manufactured from a fluted sheet material.

2. A blank as claimed in claim 1, wherein each flap is rectangular in shape.

3. A blank as claimed in claim 1, wherein the cut-outs and the lines of weakness around it are semi-circular.

4. A blank as claimed in claim 1, wherein the lines of weakness permit portions of the flaps around the cut-outs to be removed when desired.

5. A blank as claimed in claim 1, wherein the female engaging formations are in the form of slots.

6. A blank as claimed in claim 5, wherein the male engaging formations are generally T-shaped and include a neck portion that is slightly narrower than the slots and a head portion that is wider than the slots.

7. A blank as claimed in claim 1, wherein the blank is manufactured from the group consisting of: a synthetic plastics material and cardboard.

8. A blank as claimed in claim 1, wherein the blank is manufactured from Correx Board.

9. A blank as claimed in claim 1, wherein two of the trapezoidal panels include a cut-out arranged toward the widest part of the panels for in use receiving a water conduit therethrough.

10. A blank as claimed in claim 9, wherein, in use, a fluid atomiser extends from the conduit and terminates in an interior of the device.

11. A plant protection and water saving device made from a blank, the blank comprising:
(a) four generally trapezoidal panels arranged in a row and connected to each other at a widest part of each panel, which panels in use form four side walls of the device;
(b) two flaps, each extending from one trapezoidal panel at a narrowest part of the panel, a cut-out being defined at a free leading edge of each flap and several spaced apart lines of weakness being provided around the cut-out; and
(c) male and female engaging formations arranged at free sides of the panels and flaps to permit fastening of the panels and flaps to each other in use; wherein the blank is manufactured from a fluted sheet material.
